(19) United States
(12) Patent Application Publication
(10) Pub. No.: US 2014/0274114 A1
(43) Pub. Date: Sep. 18, 2014

(54) Positioning based on signals injected into concealed infrastructure

(71) Applicant: QUALCOMM Incorporated, San Diego, CA (US)

(72) Inventor: Douglas ROWITCH, Honolulu, HI (US)

(21) Appl. No.: 13/831,435

(22) Filed: Mar. 14, 2013

(51) Int. Cl. H04W 4/04

(52) U.S. Cl. CPC H04W 4/04
USPC 455/456.1

(57) ABSTRACT

Disclosed are systems, methods and devices for positioning operations based, at least in part, on measurements or observations of energy emanating from building infrastructure concealed in walls obtained a mobile device. In one implementation, the energy emanating from the building infrastructure in emanates in response to one or more signals injected into the building infrastructure.

### BRIEF DESCRIPTION

1. Field

Embodiments described herein are directed to mobile navigation techniques.

2. Information

Global navigation satellite systems (GNSSs) and other like satellite positioning systems (SPSs) have enabled navigation services for mobile handsets in outdoor environments. A number of technologies are under consideration to enable accurate indoor positioning: (a) high sensitivity GNSS, (b) WiFi positioning, (c) cellular positioning, (d) inertial sensor augmentation, (e) other beacon positioning (e.g., Bluetooth™, UWB, RFID, NFC, etc.). In one such technique, Patel, et al. propose the idea of Power Line Positioning (PLP) where signal generators injected tones into power lines in a home or building, leveraging similar technology than that which is used for home or building automation. Here signals may be injected with a sufficient strength and intensity to emanate out of power lines and into the space within a structure such that mobile devices may measure the presence or strength of the emanating tone(s) and amplitude. A mobile device may compare tone(s) or amplitude detected in the emanating signals with an expected signature indicative of specific locations in an area covered by the structure to obtain a position fix using a “fingerprinting” technique.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a system diagram illustrating certain features of a system containing a mobile device, in accordance with an implementation.

FIG. 2 is a flow diagram of a process for combining observations or measurements according to an embodiment.

FIG. 3A is a flow diagram of a process to collect measurements or observations of aspects of energy emanating from building infrastructure according to an embodiment.

FIG. 3B is a map of a portion of an interior area according to an embodiment.

FIG. 3C is a flow diagram of a process to collect measurements or observations of aspects of energy emanating from building infrastructure according to an alternative embodiment.

FIG. 4 is a flow diagram of a process for estimating a location of a mobile device in accordance with an embodiment.

FIG. 5 is a flow diagram of a process for obtaining an estimated location of a mobile device according to an embodiment.

FIG. 6 is a schematic block diagram illustrating an exemplary device, in accordance with an implementation.

FIG. 7 is a schematic block diagram of an example computing platform in accordance with an implementation.

### SUMMARY

Briefly, particular implementations are directed to a method comprising, at an end user mobile device: observing or measuring one or more aspects of signals emanating from infrastructure concealed in walls, said signals emanating at least in part in response to an injected signal; obtaining an observation of a current location of the end user mobile device contemporaneously with the observing or measuring the one or more aspects based, at least in part, on an estimated difference between said current location and a previously known location of the end user mobile device; and transmitting one or more messages containing said observed or measured one or more aspects and said observation to a server for use in computing positioning assistance data.

Another particular implementation is directed to: an end user mobile device comprising: a transmitter to transmit messages though a communication network; and one or more processors to: observe or measure one or more aspects of signals emanating from infrastructure concealed in walls, said signals emanating at least in part in response to an injected signal; obtain an observation of a current location of the end user mobile device contemporaneously with the observing or measuring the one or more aspects based, at least in part, on an estimated difference between said current location and a previously known location of the end user mobile device; and initiate transmission of one or more messages through said transmitter containing said observed or measured one or more aspects and said observation to a server for use in computing positioning assistance data.

Another particular implementation is directed to an article comprising: a non-transitory storage medium comprising machine-readable instructions stored thereon which are executable by a special purpose computing apparatus to: obtain an observation or measurement of one or more aspects of signals emanating from infrastructure concealed in walls, said signals emanating at least in part in response to an injected signal; obtain an observation of a current location of the end user mobile device contemporaneously with the observing or measuring the one or more aspects based, at least in part, on an estimated difference between said current location and a previously known location of the end user mobile device; and initiate transmission of one or more messages containing said observed or measured one or more aspects and said observation to a server for use in computing positioning assistance data.

Another particular implementation is directed to an apparatus comprising: means for observing or measuring one or more aspects of signals emanating from infrastructure concealed in walls, said signals emanating at least in part in response to an injected signal; means for obtaining an observation of a current location of the end user mobile device contemporaneously with the observing or measuring the one or more aspects based, at least in part, on an estimated difference between said current location and a previously known location of the end user mobile device; and means for transmitting one or more messages containing said observed or measured one or more aspects and said observation to a server for use in computing positioning assistance data.

Another particular implementation is directed to a method comprising, at an end user mobile device: observing or measuring one or more aspects of signals emanating from infrastructure concealed in walls, said signals emanating at least in part in response to an injected signal; obtaining an observation of a current location of the end user mobile device contemporaneously with the observing or measuring the one or more aspects based, at least in part, on a user selection on a touchscreen of said end user mobile device over a location on a map displayed on said touchscreen; and transmitting one or more messages containing said observed or measured one or more aspects and said observation to a server for use in computing positioning assistance data.

Another particular implementation is directed to an end user mobile device comprising: a transceiver to transmit messages to and receive messages from a wireless network; a touch screen device; and one or more processors to: obtain an observation or measurement of one or more aspects of signals emanating from infrastructure concealed in walls, said signals emanating at least in part in response to an injected signal; obtain an observation of a current location of the end user mobile device contemporaneously with the observing or measuring the one or more aspects based, at least in part, on a user selection on said touchscreen device over a location on a map displayed on said touchscreen; and initiate transmission of one or more messages through said transceiver containing said observed or measured one or more aspects and said observation to a server for use in computing positioning assistance data.

Another particular implementation is directed to an article comprising: a non-transitory storage medium comprising machine-readable instructions stored thereon which are executable by a special purpose computing apparatus of an end user mobile device to: obtain an observation or measurement of one or more aspects of signals emanating from infrastructure concealed in walls, said signals emanating at least in part in response to an injected signal; obtain an observation of a current location of the end user mobile device contemporaneously with the observing or measuring the one or more aspects based, at least in part, on a user selection on said touchscreen device over a location on a map displayed on said touchscreen; and initiate transmission of one or more messages containing said observed or measured one or more aspects and said observation to a server for use in computing positioning assistance data.

Another particular implementation is directed to an apparatus comprising: means for observing or measuring one or more aspects of signals emanating from infrastructure concealed in walls, said signals emanating at least in part in response to an injected signal; means for obtaining an observation of a current location of the end user mobile device contemporaneously with the observing or measuring the one or more aspects based, at least in part, on a user selection on a touchscreen of said end user mobile device over a location on a map displayed on said touchscreen; and means for transmitting one or more messages containing said observed or measured one or more aspects and said observation to a server for use in computing positioning assistance data.

It should be understood that the aforementioned implementations are merely example implementations, and that claimed subject matter is not necessarily limited to any particular aspect of these example implementations.

### DETAILED DESCRIPTION

As mentioned above, signals may be injected into electrical power wiring of a building may radiate detectable energy that may be used by a mobile device in positioning operations. Further, it may be observed that a signal strength of an observed emanating signal may decay as a function of distance from the transmitter/signal injector. As the path of electrical wiring may be unknown and not mimic a line-of-sight path between a receiving mobile device and a signal injector, the observed signals may scale with distance, but suffer distortion like radio frequency signals in a harsh multipath environment. As such, radio frequency fingerprinting techniques may involve matching observed power line signal signatures with expected signature values in a fingerprint or heatmap database generated by a site survey. This scheme has been documented in a journal paper entitled “PowerLine Positioning: A Practical Sub-Room-Level Indoor Location System for Domestic Use” by Shwetak N. Patel, Khai N. Truong, and Gregory D. Abowd. Similar techniques are shown in US patent publications US20080091345(A1) and US20100109842(A1).

In a particular implementation, a crowd sourcing method for developing a fingerprint or heatmap database may be employed as a more efficient and cost-effective alternative than conducting a site survey. Here, for example, a mobile device may measure aspects of signal emanating from building infrastructure concealed in walls and correlate these measured aspects with a contemporaneously observed location of the mobile device (e.g., location estimate or data point). The mobile device may then transmit messages containing these measured aspects and contemporaneously observed location to a server. Here, the server may combine the measured aspects and contemporaneous observations of location with similar information obtained from other mobile devices to derive expected signature values for fingerprint or heatmap database, which may be provided as positioning assistance data.

In particular implementations, signal injector functionality may be combined within other device types such as, for example, WiFi Access Points, femtocells, picocells, appliances, alternating current-powered consumer electronics and security devices, and/or other home automation devices. In addition to or in the alternative to injecting positioning signals into electrical wiring, a signal injector may inject positioning signals into other infrastructure including, for example, metal framing of a building, plumbing pipes, HVAC ducts, etc.

In certain implementations, as shown in FIG. 1, a mobile device 100 may detect signals emanating from building infrastructure responsive to signal injection. Walls 122 may conceal building infrastructure (not shown) including, for example, electrical power wiring, metal plumbing, structural members (e.g., beams, posts, headers, etc.), HVAC ducting, just to provide a few examples. At various portions of a building, electrical and/or mechanical energy may be injected to the concealed building infrastructure.

Injectors may be attached or coupled to points of concealed building infrastructure to impart or inject signal energy at the point of attachment that radiates outward. An injector may inject energy as an electrical signal, audio/acoustical signal mechanical signal (e.g., vibration), light signal, just to provide a few examples. Further, injectors may inject signal energy a particular power level and at a particular frequency tailored to resonance properties of concealed infrastructure members that are to transmit emanating signals that are detectable. Furthermore, in particular implementations, one or more injectors may be installed at a particular site at different locations or different infrastructure members to provide multiple signal sources. In one particular implementation, an injector may be installed at a central location. In other implementations, multiple injectors may be installed at distributed locations.

In another particular implementation, an injector may comprise a household appliance (e.g., refrigerator, electric cooking range, dishwasher, hair dryer, lamp, etc.) that is capable of injecting a signal (e.g., into utility power line). Here, a household appliance plugged into a wall outlet may be capable of injecting a signal into power lines for transmission to a junction box and beyond. Detectable energy from the injected signal may then be transmitted through walls to be detected by mobile devices for positioning operations.

As illustrated in FIG. 1, an injected energy signal may be transmitted along the concealed infrastructure and emanate from walls 122 as detectable energy 124. As described below, mobile device 100 may comprise sensors and/or circuitry capable of detecting or characterizing detectable energy 124. In one implementation, mobile device 100 may be capable of matching or associating characterized detectable energy 124 with expected signature values at predetermined locations in an area to estimate a location of a mobile device. In other implementations, mobile device 100 may tag measurements or observations of detectable energy 124 with contemporaneously obtained observations of locations of mobile device 100 for use in developing expected signature values for use in subsequent positioning operations.

Mobile device 100 may obtain contemporaneous observations of its location using any one of several particular techniques. In one example, mobile device 100 may receive or acquire satellite positioning system (SPS) signals 159 from SPS satellites 160. In some embodiments, SPS satellites 160 may be from one global navigation satellite system (GNSS), such as the GPS or Galileo satellite systems. In other embodiments, the SPS Satellites may be from multiple GNSS such as, but not limited to, GPS, Galileo, Glonass, or Beidou (Compass) satellite systems. In other embodiments, SPS satellites may be from any one several regional navigation satellite systems (RNSS') such as, for example, Wide Area Augmentation System (WAAS), European Geostationary Navigation Overlay Service (EGNOS), Quasi-Zenith Satellite System (QZSS), just to name a few examples. In other implementations, a mobile device may contemporaneously observe its location based, at least in part, on signals received from inertial navigation signals (e.g., applying techniques such as dead reckoning).

In addition, mobile device 100 may transmit radio signals to, and receive radio signals from, a wireless communication network. In one example, mobile device 100 may communicate with a cellular communication network by transmitting wireless signals to, or receiving wireless signals from, base station transceiver 110 over wireless communication link 123. Similarly, mobile device 100 may transmit wireless signals to, or receive wireless signals from local transceiver 115 over wireless communication link 125.

In a particular implementation, local transceiver 115 may be configured to communicate with mobile device 100 at a shorter range over wireless communication link 125 than at a range enabled by base station transceiver 110 over wireless communication link 123. For example, local transceiver 115 may be positioned in an indoor environment. Local transceiver 115 may provide access to a wireless local area network (WLAN, e.g., IEEE Std. 802.11 network) or wireless personal area network (WPAN, e.g., Bluetooth™ network). In another example implementation, local transceiver 115 may comprise a femto cell transceiver capable of facilitating communication on wireless communication link 125 according to a cellular communication protocol. Of course it should be understood that these are merely examples of networks that may communicate with a mobile device over a wireless link, and claimed subject matter is not limited in this respect.

In a particular implementation, base station transceiver 110 and local transceiver 115 may communicate with servers 140, 150 and/or 155 over a network 130 through links 145. Here, network 130 may comprise any combination of wired or wireless links. In a particular implementation, network 130 may comprise Internet Protocol (IP) infrastructure capable of facilitating communication between mobile device 100 and servers 140, 150 or 155 through local transceiver 115 or base station transceiver 110. In another implementation, network 130 may comprise cellular communication network infrastructure such as, for example, a base station controller or master switching center (not shown) to facilitate mobile cellular communication with mobile device 100.

In particular implementations, and as discussed below, mobile device 100 may have circuitry and processing resources capable of computing a position fix or estimated location of mobile device 100. For example, mobile device 100 may compute a position fix based, at least in part, on pseudorange measurements to four or more SPS satellites 160. Here, mobile device 100 may compute such pseudorange measurements based, at least in part, on pseudonoise code phase detections in signals 159 acquired from four or more SPS satellites 160. In particular implementations, mobile device 100 may receive from server 140, 150 or 155 positioning assistance data to aid in the acquisition of signals 159 transmitted by SPS satellites 160 including, for example, almanac, ephemeris data, Doppler search windows, just to name a few examples.

In other implementations, mobile device 100 may obtain a position fix by processing signals received from terrestrial transmitters fixed at known locations (e.g., such as base station transceiver 110) using any one of several techniques such as, for example, advanced forward trilateration (AFLT) and/or observed time difference of arrival (OTDOA). In these particular techniques, a range from mobile device 100 may be measured to three or more of such terrestrial transmitters fixed at known locations based, at least in part, on pilot signals transmitted by the transmitters fixed at known locations and received at mobile device 100. Here, servers 140, 150 or 155 may be capable of providing positioning assistance data to mobile device 100 including, for example, locations and identities of terrestrial transmitters to facilitate positioning techniques such as AFLT and OTDOA. For example, servers 140, 150 or 155 may include a base station almanac (BSA) which indicates locations and identities of cellular base stations in a particular region or regions.

In particular environments such as indoor environments or urban canyons, mobile device 100 may not be capable of acquiring signals 159 from a sufficient number of SPS satellites 160 or perform AFLT or OTDOA to compute a position fix. Alternatively, mobile device 100 may be capable of computing a position fix based, at least in part, on signals acquired from local transmitters (e.g., WLAN access points, femto cell transceivers, Bluetooth devices, etc., positioned at known locations). Such local transmitters may include transceivers 115 and beacon transmitter 104. For example, mobile devices may obtain a position fix by measuring ranges to three or more indoor terrestrial wireless access points and/or beacons which are positioned at known locations. Such ranges may be measured, for example, by obtaining a MAC ID address from signals received from such access points and obtaining range measurements to the access points by measuring one or more characteristics of signals received from such access points such as, for example, received signal strength (RSSI) or round trip time (RTT) (e.g., for transceivers). In alternative implementations, mobile device 100 may obtain an indoor position fix by applying characteristics of acquired signals to a radio heatmap indicating expected RSSI and/or RTT signatures at particular locations in an indoor area. In particular implementations, a radio heatmap may associate identities of local transmitters (e.g., a MAC address which is discernible from a signal acquired from a local transmitter), expected RSSI from signals transmitted by the identified local transmitters, an expected RTT from the identified transmitters, and possibly standard deviations from these expected RSSI or RTT. It should be understood, however, that these are merely examples of values that may be stored in a radio heatmap, and that claimed subject matter is not limited in this respect.

In particular implementations, mobile device 100 may receive positioning assistance data for indoor positioning operations from servers 140, 150 or 155. For example, such positioning assistance data may include locations and identities of transmitters positioned at known locations to enable measuring ranges to these transmitters based, at least in part, on a measured RSSI and/or RTT, for example. Other positioning assistance data to aid indoor positioning operations may include radio heatmaps, locations and identities of transmitters, routeability graphs, just to name a few examples. Other assistance data received by the mobile device may include, for example, local maps of indoor areas for display or to aid in navigation. Such a map may be provided to mobile device 100 as mobile device 100 enters a particular indoor area. Such a map may show indoor features such as doors, hallways, entry ways, walls, etc., points of interest such as bathrooms, pay phones, room names, stores, etc. By obtaining and displaying such a map, a mobile device may overlay a current location of the mobile device (and user) over the displayed map to provide the user with additional context.

In one implementation, a routeability graph and/or digital map may assist mobile device 100 in defining feasible areas for navigation within an indoor area and subject to physical obstructions (e.g., walls) and passage ways (e.g., doorways in walls). Here, by defining feasible areas for navigation, mobile device 100 may apply constraints to aid in the application of filtering measurements for estimating locations and/or motion trajectories according to a motion model (e.g., according to a particle filter and/or Kalman filter). In addition to measurements obtained from the acquisition of signals from local transmitters, according to a particular embodiment, mobile device 100 may further apply a motion model to measurements or inferences obtained from inertial sensors (e.g., accelerometers, gyroscopes, magnetometers, etc.) and/or environment sensors (e.g., temperature sensors, microphones, barometric pressure sensors, ambient light sensors, camera imager, etc.) in estimating a location or motion state of mobile device 100.

According to an embodiment, mobile device 100 may access indoor navigation assistance data through servers 140, 150 or 155 by, for example, requesting the indoor assistance data through selection of a universal resource locator (URL). In particular implementations, servers 140, 150 or 155 may be capable of providing indoor navigation assistance data to cover many different indoor areas including, for example, floors of buildings, wings of hospitals, terminals at an airport, portions of a university campus, areas of a large shopping mall, just to name a few examples. Also, memory resources at mobile device 100 and data transmission resources may make receipt of indoor navigation assistance data for all areas served by servers 140, 150 or 155 impractical or infeasible. A request for indoor navigation assistance data from mobile device 100 may indicate a rough or course estimate of a location of mobile device 100. Mobile device 100 may then be provided indoor navigation assistance data covering areas including and/or proximate to the rough or course estimate of the location of mobile device 100.

As pointed out above, mobile device 100 may associate observations of detectable energy 124 with contemporaneous observations of a location of mobile device 100 for use in constructing expected signature values of observations at locations in an area of interest. In a particular implementation, such associations of observations of energy 124 with contemporaneous observations of locations may be obtained from multiple mobile devices and combined to construct crowdsourced expected signature values to be observed at locations of interest in an area.

In one implementation, mobile device 100 may transmit messages to a central server (e.g., server 140, 150 or 155) including measurements or observations of energy 124 paired with contemporaneous observations of a location of mobile device 100. Other mobile devices (not shown) may transmit similar messages to the central server including measurements or observations of energy 124 paired with contemporaneous observations of locations of the other mobile devices. The central server may then combine observations of energy 124 paired with contemporaneous ground-truth observations in messages received from multiple mobile devices to construct crowdsourced expected signature values to be observed at locations of interest in an area. In one implementation, crowdsourced signature values may be organized as a heatmap database defining discrete locations in an area (e.g., grid points on a rectangular grid over the area of interest) which are associated with respective expected measurements or observations of aspects of observations of energy 124 at the discrete locations. Here, signature values associated with a discrete location defined in an heatmap may comprise, for example, mean values and expected standard deviations of particular measurable/observable aspects of energy 124 at the discrete location (e.g., received signal power, etc.).

As pointed out above, mobile device 100 may receive positioning assistance data from a location server (e.g., server 140, 150 or 155). In another implementation, positioning assistance data available from a location server may include values indicative of expected observations of energy 124 at discrete locations computed using crowdsourced measurements as discussed above. As described above, these values may be computed as crowdsourced signature values organized in a heatmap database defining discrete locations in an area.

In an alternative implementation, a value indicative of expected measurements or observations of energy 124 at a discrete location may be computed based, at least in part, on energy or power applied by signal injectors at source locations, a distance between the source locations and the discrete location, and propagation/attenuation models. Here, values indicative of expected observations of aspects of energy 124 at multiple discrete locations may be computed and maintained in a heatmap database to be provided to mobile devices as positioning assistance data.

As pointed out above and discussed below, mobile device 100 may obtain measurements or observations of energy 124 and contemporaneous observations of a location of mobile device 100. Measurements or observations of energy 124 paired with the contemporaneous observations of the location of mobile device may then be forwarded to a server for use in computing positioning assistance data. In particular environments, however, observations of a location of mobile device 100 may be unreliable or difficult to obtain. For example, in particular areas of interest (e.g., particular indoor environments), mobile device 100 may not be capable of acquiring SPS signals or WLAN signals for use in obtaining a position fix using techniques above. Accordingly, alternative positioning techniques may be used.

In one example implementation, mobile device 100 may be capable of obtaining an accurate or reliable observation of its location at the perimeter of an indoor space (e.g., locations by an entry way or window where acquisition of SPS signals or cellular signals is possible). If mobile device 100 is capable of obtaining inertial sensor measurements (e.g., measurements of signals from one or more accelerometers, magnetometers, gyroscopes, etc.), mobile device 100 may apply dead reckoning techniques to track its location from a last reliable position fix (e.g., GPS position fix at a doorway). In another implementation, mobile device 100 may comprise a camera with an image capture device and a processor capable of associating captured image Visual recognition techniques (e.g., at a barcode or other image). In another implementation, mobile device 100 may be capable of observing its position based, at least in part, on power line positioning measurements.

In a particular example scenario, expected signature values for measurements or observations of energy 124 provided as positioning assistance data may be more accurate at the perimeter of a space (e.g., where mobile devices can obtain a position fix from acquisition of SPS signals or cellular network signals). Over time with additional crowdsourced measurements or observations of energy 124, however, expected signature values for spaces more interior from the perimeter may become increasingly accurate and reliable, and likewise more useful. Here, additional crowdsourced measurements may be processed by a filter/interpolator to update computed expected signature values for measurements or observations of energy 124 in these more interior spaces to enable expected signature values to converge.

In a particular implementation, and as discussed below in a particular implementation, mobile device 100 may comprise an “end user” mobile device in that measurement of signals for recording purposes is not the sole purpose of the device. For example, an end user device may provide hardware, processing resources, radio frequency circuitry, a user interface, etc., that is capable of delivering a service to an end user consumer. This may be distinguished from technical equipment or instrumentation operated by a technician for a more limited purposes of obtaining and collecting measurements in connection with a site survey, for example. As used elsewhere herein, the term “mobile device” may refer to an “end user mobile device” in particular implementations.

FIG. 2 is a flow diagram of a process for combining multiple observations from one or more mobile devices to construct crowdsourced signature values indicative of expected measurements or observations of aspects of observable energy at locations defined in an area of interest according to an embodiment. Such energy may emanate from building infrastructure concealed in walls in response to energy that is injected into the building infrastructure as discussed above in connection with FIG. 1. At block 202, a server may receive messages from one or more mobile devices comprising measurements or observations of energy emanating from concealed building infrastructure (e.g., energy 124) paired with contemporaneous observations of locations of the mobile devices. These messages may be received from wireless communication links employing any one of the several wireless communication technologies identified above. At block 204, pairings of observations or measurements of energy and observations of locations received at block 202 may be combined to derive expected signature values indicative of observations at particular predefined locations (e.g., as defined in a heatmap). Measurements or observations of energy may be interpolated to specific predefined locations expected based, at least in part, on respective location observations paired with the measurements or observations of energy. As pointed out above, signature values indicative of expected measurements or observations may comprise mean values and/or expected standard deviations.

FIG. 3A is a flow diagram of a process to collect measurements or at a mobile device for use in computing expected signatures of observable energy at locations in an area. At block 302, a mobile device may observe or measure one or more aspects of energy emanating from concealed building infrastructure (e.g., in response to energy injected into the concealed building infrastructure as described above). Here, the mobile device collecting the observations may comprise a combination of receivers and/or sensors to sense, measure or observe aspects of energy (e.g., radio frequency, acoustical vibration, light energy, etc.) emanating from concealed infrastructure. For example, in addition to having a receiver for use in data communication (e.g., for cellular or WLAN communication), a mobile device may have a separate receiver and antenna adapted to observe energy at different (e.g., lower) frequencies. Such aspects of observed energy may comprise, for example, signal power, frequency, power spectral density, temporal power profile, just to provide a few examples. It should be understood, however, that these are merely examples of aspects of detectable energy that may be measured or observed, and that claimed subject matter is not limited in this respect. At block 304, a mobile device may, as pointed out above, obtain observations of the mobile device's current location using any one of the several positioning techniques identified above contemporaneous with obtaining measurements or observations at block 302. At block 306, the mobile device may transmit one or more messages to a server containing measurements or observations of energy obtained at block 302 paired with contemporaneous observations of location of the mobile device for processing (e.g., as described in process 200 of FIG. 2).

In alternative implementations of block 304, a mobile device may obtain an observation of its location using different techniques. For example, a mobile device may obtain an observation of its location from messages transmitted to the mobile device from a remote entity (e.g., location server). In another example implementation, a mobile device may obtain an observation of its location based, at least in part, on applying positioning assistance data to observations or measurements of one or more aspects of signals emanating from infrastructure concealed in walls as described in FIG. 4. It should be understood, however, that these are merely examples of how a mobile device may obtain observations of its location, and claimed subject matter is not limited in this respect.

As pointed out above, a mobile device may be capable of accurately and reliably observing its location at block 304 while in particular portions of an indoor area such as, for example, peripheral portions where GNSS navigation may be available. Observations obtained while in an interior portion (e.g., in the absence of detectable SPS or indoor navigation signals transmitted from a WLAN access point), on the other hand, may be less accurate or reliable.

In one implementation, an observation of a mobile device's location transmitted at block 306 may be accompanied with an indication of reliability or uncertainty in the observation such as, for example, a radius of uncertainty. In another implementation, a mobile device may obtain observations or measurements of one or more aspects of the aforementioned emanating signals (e.g., energy 124) as the mobile device travels along a path in an indoor area. At least one end point of the path (e.g., at the beginning or at the end of the path) may be at a reliably known location such as, for example, an exterior doorway where the mobile device is capable of obtaining an accurate and reliable position fix from the acquisition of SPS signals. For measurements or observations of the aforementioned emanating signals obtained while the mobile device is at this end point, the mobile device may be capable of providing an accurate contemporaneous observation of the mobile device's location at block 306 for use in crowdsourcing discussed above at block 204 (FIG. 2). For measurements or observations of the aforementioned emanating signals obtained as the mobile device travels along the path moving away from the endpoint, the mobile device may be capable of only providing substantially less accurate contemporaneous observations of the mobile device's location at block 306.

FIG. 3B shows a map of a portion of an indoor area 350. A mobile device may travel a path 352 in indoor area 350 including an entry or exit at a doorway 358. If the mobile device is capable of obtaining a position fix at doorway 358 (e.g., from acquiring SPS signals), such a position fix may provide a reliable and accurate observation of a location of the mobile device at an endpoint on path 352. On other portions of path 352 extending into the interior of indoor area 350, the mobile device may not be capable of acquiring SPS signals (or indoor navigation signals from WLAN access points) and therefore may be limited to observing changes in the mobile device's location from a known location based on measurements from inertial sensors such as accelerometers, magnetometers, gyroscopes or the like. Here, the mobile device may estimate its location along path 352 using dead reckoning from a position fix obtained at doorway 358. However, such observations based on dead reckoning may provide observations of locations of the mobile device which are significantly less accurate and reliable than a position fix obtained from acquisition of SPS signals, for example.

According to an embodiment, a mobile device may be capable of associating its current location to features on an electronic map (e.g., provided as assistance data as described above). For example, measurement signals from inertial sensors may indicate a turn 354 in path 352, which may be referenced to a specific known location of an intersection of hallways in the indoor area. Similarly, measurement signals from inertial sensors may indicate a turn 356 in path 352, which may be referenced to another specific known location at an intersection of hallways in the indoor area. In other implementations, a mobile device may obtain measurements from environmental sensors (e.g., microphone, light detector(s), temperature sensors, atmospheric pressure sensors, etc.) and associate such measurements obtained from environmental sensors with a specific location along path 352.

According to an embodiment, a crowdsourcing server may combine the aforementioned measurements or observations of an aspect of emanating energy paired with contemporaneous observations of locations (e.g., at block 204) to determine expected signature values along path 352. In one implementation, the crowdsourcing server may model such an expected signature value along path 352 as function that varies based, at least in part, on a location along path 352. Such a function may be characterized based on one or more parameters and/or comprise a gradient function, continuous function, smooth function, increasing function, decreasing function, just to provide a few examples. Parameters characterizing such a function may be estimated using curve fitting techniques (e.g., linear or non-linear regression) applied to measurements or observations of an aspect of emanating energy paired with contemporaneous observations of locations from multiple mobile devices having travelled along path 352.

In an alternative implementation, in computing expected signature values of energy emanating from calls in an area, a crowdsourcing server (e.g., at block 204) may attempt to arrange paired observations in a particular order or arrangement on locations along path 352. For example, consider observations 1, 2, 3 and 4 at respective ordered locations A, B, C and D on a portion of path 352 associated with estimated error radii a, b, c and d. If the observations 1, 2, 3 and 4 are taken with the same mobile device while the mobile device is in motion along the portion of path 352 in a reasonably smooth direct manner (e.g., being carried by a person while walking down a hall rather than stopping and talking or zigzagging), the time of the observations 1, 2, 3 and 4 may be used to establish an ordinality of/arrangement of the observations. If observed signal strength (e.g., of energy emanating from walls) is decreasing from observations 1 to observation 3, decreasing from observation 3 to observation 2, and decreasing from observation 2 to observation 4, and if estimated error radii b and c overlap as shown in FIG. 3B, the crowdsourcing server may reorder (e.g., swap) observations 2 and 3 at positions B and C consistent with a model or expectation of decreasing signal strength from location A through location D along path 352. In a particular implementation, at onset of use, there may be relatively few observations initially and the mapping of those observations may be subject to different inaccuracies of alternate positioning methods such as GNSS indoors (inaccurate) or dead reckoning (subject to drift and device movement, etc.). Thus, establishing an order of observations by different devices may relate to each other in a given hallway or area (e.g., along path 352) may assist developing expected signatures at locations in an area while avoiding discontinuities/oscillations/perturbation (e.g., increasing or decreasing signal strength) with movement along a path.

As pointed out above, expected signature values for emanating energy at locations in an interior portion of an indoor area may not be well developed initially. Additionally, observations of a mobile devices location in the interior portion of the indoor area may be initially inaccurate in the absence of SPS signals or indoor navigation signals (e.g., relying on inertial sensor measurements for dead reckoning from an endpoint in a path as discussed above). As expected signature values of emanating energy are developed for locations in the interior portion as discussed above, subsequent observations of location of the mobile device obtained contemporaneously measurements or observations of emanating energy may become increasingly accurate over time.

In another alternative embodiment, a mobile device may obtain a contemporaneous observation of its location based, at least in part, on a user input as shown in process 360 of FIG. 3C. Blocks 362 may observe or measure one or more aspects of signals emanating from infrastructure as described above. Likewise, block 366 may transmit paired measurements or observations of aspects of emanating signals paired with contemporaneous observations of location as discussed above. In a particular implementation, a mobile device may comprise a touch screen and host an application that displays a map of an area (e.g., obtained from positioning assistance data as discussed above) over the touch screen. At block 364, however, a mobile device may receive a selection from a user on a touchscreen over a location on a map displayed on the touch screen.

FIG. 4 is a flow diagram of a process 400 for obtaining a position fix at a mobile device according to an embodiment. Block 402 may obtain observations or measurements of one or aspects of signals emanating from infrastructure concealed in walls using techniques described above. As pointed out above the signals emanating from infrastructure in walls may emanate at least in part in response to a signal injected into power lines, plumbing, structural members, HVAC ducting or the like. Block 404 may receive assistance data from an entity that is remote from the mobile device such as a location server. As pointed out above, this assistance data may comprise a heatmap expected signature values indicative of an expected measurement or observation at predetermined locations in an area. It should be understood that blocks 402 and 404 may occur in any particular sequence. Block 406 may estimate a location of the mobile device based, at least in part, on application of positioning assistance data obtained at block 404 to aspects of signals observed or measured at block 402. Here, block 406 may compare the observed or measured aspects with expected signature values in the assistance data to find a map. An estimated location may then be determined or selected based, at least in part, on a location defined in a heatmap for a matched signature value.

FIG. 5 is a flow diagram of a process 500 for obtaining a position fix at a mobile device according to an alternative implementation. Block 502 may obtain observations or measurements of one or aspects of signals emanating from infrastructure concealed in walls using techniques described above in connection with block 402. Instead of obtaining positioning assistance from a remote entity, however, the mobile device at block 504 may transmit one or more messages to an entity remote from the mobile device determined by or including observations or measurements obtained at block 502. Here, the remote entity may determine an estimated location of the mobile device based, at least in part, on messages transmitted at block 504. At block 506, the mobile device may receive one or more messages from the remote entity including the determined estimated location of the mobile device.

FIG. 6 is a schematic diagram of a mobile device according to an embodiment. Mobile device 100 (FIG. 1) may comprise one or more features of mobile device 1100 shown in FIG. 6. In certain embodiments, mobile device 1100 may also comprise a wireless transceiver 1121 which is capable of transmitting and receiving wireless signals 1123 via an antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to a corresponding multiple wireless communication standards such as, for example, WiFi, CDMA, WCDMA, LTE and Bluetooth, just to name a few examples.

Mobile device 1100 may also comprise SPS receiver 1155 capable of receiving and acquiring SPS signals 1159 via SPS antenna 1158. SPS receiver 1155 may also process, in whole or in part, acquired SPS signals 1159 for estimating a location of mobile device 1100. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals for use in performing positioning operations may be performed in memory 1140 or registers (not shown).

Also shown in FIG. 6, mobile device 1100 may comprise digital signal processor(s) (DSP(s)) 1112 connected to the bus 1101 by a bus interface 1110, general-purpose processor(s) 1111 connected to the bus 1101 by a bus interface 1150 and memory 1140. Bus interface 1110 may be integrated with the DSP(s) 1112, general-purpose processor(s) 1111 and memory 1140. In various embodiments, functions may be performed in response execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 512. Memory 1140 may comprise a non-transitory processor-readable memory and/or a computer-readable memory that stores software code (programming code, instructions, etc.) that are executable by processor(s) 1111 and/or DSP(s) 1112 to perform functions described herein.

Also shown in FIG. 6, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112 or general purpose processor/application processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device (e.g., laid over a display device to receive user input selections relative to images presented on the display device).

Mobile device 1100 may also comprise a dedicated camera device 1164 for capturing still or moving imagery. Camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, video processor 1168 may decode/decompress stored image data for presentation on a display device (not shown) on mobile device 1100.

Mobile device 1100 may also comprise sensors 1160 coupled to bus 1101 which may include, for example, inertial sensors and environment sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by DPS(s) or general purpose processor/application processor 1111 in support of one or more applications such as, for example, applications directed to positioning or navigation operations.

In addition to the aforementioned alternative implementation of sensors 1160, sensors 1160 may include additional sensors responsive to energy emanating from building infrastructure concealed by walls (e.g., for use in observing or measuring one or more aspects of the emanating energy). In one implementation, In addition, may comprise a separate wireless receiver and antenna (not shown) for observing or measuring radio frequency energy emanating from infrastructure concealed in walls (e.g., energy 124) at lower frequency bands than at wireless transceiver 1121. For example, sensors 1160 may further include acoustical sensor arrays for detecting subsonic vibrations, light sensor, a separate radio frequency receiver (e.g., for detecting RF signals in a lower frequency than is measurable/observable at wireless sensor 1121).

In a particular implementation, mobile device 1100 may comprise a dedicated modem processor 1166 capable of performing baseband processing of signals received and downconverted at wireless transceiver 1121 or SPS receiver 1155. Similarly, modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

FIG. 7 is a schematic diagram illustrating an example system 1200 that may include one or more devices configurable to implement techniques or processes described above, for example, in connection with FIG. 1. System 1200 may include, for example, a first device 1202, a second device 1204, and a third device 1206, which may be operatively coupled together through a wireless communications network 1208. In an aspect, first device 1202 may comprise a server capable of providing positioning assistance data such as, for example, a base station almanac. Second and third devices 1204 and 1206 may comprise mobile devices, in an aspect. Also, in an aspect, wireless communications network 1208 may comprise one or more wireless access points, for example. However, claimed subject matter is not limited in scope in these respects.

First device 1202, second device 1204 and third device 1206, as shown in FIG. 6, may be representative of any device, appliance or machine that may be configurable to exchange data over wireless communications network 1208. By way of example but not limitation, any of first device 1202, second device 1204, or third device 1206 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1202, 1204, and 1206, respectively, may comprise one or more of a base station almanac server, a base station, or a mobile device in accordance with the examples described herein.

Similarly, wireless communications network 1208, as shown in FIG. 7, is representative of one or more communication links, processes, or resources configurable to support the exchange of data between at least two of first device 1202, second device 1204, and third device 1206. By way of example but not limitation, wireless communications network 1208 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1206, there may be additional like devices operatively coupled to wireless communications network 1208.

It is recognized that all or part of the various devices and networks shown in system 1200, and the processes and methods as further described herein, may be implemented using or otherwise including hardware, firmware, software, or any combination thereof.

Thus, by way of example but not limitation, second device 1204 may include at least one processing unit 1220 that is operatively coupled to a memory 1222 through a bus 1228.

Processing unit 1220 is representative of one or more circuits configurable to perform at least a portion of a data computing procedure or process. By way of example but not limitation, processing unit 1220 may include one or more processors, controllers, microprocessors, microcontrollers, application specific integrated circuits, digital signal processors, programmable logic devices, field programmable gate arrays, and the like, or any combination thereof.

Memory 1222 is representative of any data storage mechanism. Memory 1222 may include, for example, a primary memory 1224 or a secondary memory 1226. Primary memory 1224 may include, for example, a random access memory, read only memory, etc. While illustrated in this example as being separate from processing unit 1220, it should be understood that all or part of primary memory 1224 may be provided within or otherwise co-located/coupled with processing unit 1220.

Secondary memory 1226 may include, for example, the same or similar type of memory as primary memory or one or more data storage devices or systems, such as, for example, a disk drive, an optical disc drive, a tape drive, a solid state memory drive, etc. In certain implementations, secondary memory 1226 may be operatively receptive of, or otherwise configurable to couple to, a computer-readable medium 1240. Computer-readable medium 1240 may include, for example, any non-transitory medium that can carry or make accessible data, code or instructions for one or more of the devices in system 1200. Computer-readable medium 1240 may also be referred to as a storage medium.

Second device 1204 may include, for example, a communication interface 1230 that provides for or otherwise supports the operative coupling of second device 1204 to at least wireless communications network 1208. By way of example but not limitation, communication interface 1230 may include a network interface device or card, a modem, a router, a switch, a transceiver, and the like.

Second device 1204 may include, for example, an input/output device 1232. Input/output device 1232 is representative of one or more devices or features that may be configurable to accept or otherwise introduce human or machine inputs, or one or more devices or features that may be configurable to deliver or otherwise provide for human or machine outputs. By way of example but not limitation, input/output device 1232 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femto cell, utilized to extend cellular telephone service into a business or home. In such an implementation, one or more mobile devices may communicate with a femto cell via a code division multiple access (“CDMA”) cellular communication protocol, for example, and the femto cell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method comprising, at an end user mobile device:
observing or measuring one or more aspects of signals emanating from infrastructure concealed in walls, said signals emanating from said infrastructure concealed in walls at least in part in response to an injected signal;
obtaining an observation of a current location of the end user mobile device contemporaneously with the observing or measuring one or more aspects based, at least in part, on an estimated difference between said current location and a previously known location of the end user mobile device; and
transmitting one or more messages containing said observed or measured one or more aspects and said observation to a server for use in computing positioning assistance data.

2. The method of claim 1, and further comprising estimating said difference between said current location and said previously known location by:
obtaining a position fix at said previously known location; and
measuring movement of said end user mobile device from said position fix to said observation of said current location.

3. The method of claim 2, wherein measuring said movement further comprises measuring said movement based, at least in part, on measurements obtained from one or more inertial sensors.

4. The method of claim 2, and further comprising estimating said difference between said current location and said previously known location further by obtaining visual cue at a camera device.

5. The method of claim 2, wherein obtaining said position fix further comprises acquiring one or more satellite positioning system (SPS) signals.

6. The method of claim 2, wherein obtaining said position fix further comprises acquiring one or more signals transmitted from a wireless local area network access point.

7. The method of claim 2, wherein obtaining said position fix further comprises:
observing or measuring said one or more aspects of signals emanating from said infrastructure concealed in walls while positioned at said previously known location, said signals emanating from said infrastructure concealed in walls at least in part in response to said injected signal; and
estimating said previously known location of the end user mobile device based, at least in part, on application of previously determined positioning assistance data to said observed or measured said one or more aspects.

8. The method of claim 1, and further comprising estimating said difference between the current location and the previously known location by:
interpolating between or among the previously known location and one or more additional previously known locations of the end user mobile device.

9. The method of claim 1, wherein obtaining said observation of said current location of the end user mobile device contemporaneously with the observing or measuring the one or more aspects further comprises associating a location of the end user mobile device with a map feature based, at least in part, on measurements obtained from one or more inertial sensors.

10. The method of claim 1, wherein obtaining said observation of the current location of the end user mobile device further comprises:
obtaining a sequence of observations of locations of the end user mobile device paired with observations or measurements of the one or more aspects of signals emanating from said infrastructure concealed in walls; and
reordering said sequence of observations.

11. An end user mobile device comprising:
a transmitter to transmit messages though a communication network; and
one or more processors to:
observe or measure one or more aspects of signals emanating from infrastructure concealed in walls, said signals emanating from said infrastructure concealed in walls at least in part in response to an injected signal;
obtain an observation of a current location of the end user mobile device contemporaneously with observing or measuring the one or more aspects based, at least in part, on an estimated difference between said current location and a previously known location of the end user mobile device; and
initiate transmission of one or more messages through said transmitter containing said observed or measured one or more aspects and said observation to a server for use in computing positioning assistance data.

12. The end user mobile device of claim 11, wherein said one or more processors are further to estimate said difference between said current location and said previously known location by:
obtaining a position fix at said previously known location; and
measuring movement of said end user mobile device from said position fix to said observation of said current location.

13. The end user mobile device of claim 12, wherein the one or more processors are further to measure said movement based, at least in part, on measurements obtained from one or more inertial sensors.

14. The end user mobile device of claim 12, wherein said one or more processors are further to estimate said difference between said current location and said previously known location by obtaining visual cue at a camera device.

15. The end user mobile device of claim 12, wherein said one or more processors are to obtain said position fix based, at least in part, on acquisition of one or more satellite positioning system (SPS) signals.

16. The end user mobile device of claim 12, wherein said one or more processors are to obtain said position fix based, at least in part, on acquisition of one or more signals transmitted from a wireless local area network access point.

17. The end user mobile device of claim 12, wherein said one or more processors are to obtain said position fix by:
observing or measuring said one or more aspects of signals emanating from said infrastructure concealed in walls while positioned at said previously known location, said signals emanating from said infrastructure concealed in walls at least in part in response to said injected signal; and
estimating said previously known location of the end user mobile device based, at least in part, on application of previously determined positioning assistance data to said observed or measured said one or more aspects.

18. The end user mobile device of claim 11, wherein said one or more processors are further to estimate said difference between the current location and the previously known location by:
interpolating between or among the previously known location and one or more additional previously known locations of the end user mobile device.

19. An article comprising:
a non-transitory storage medium comprising machine-readable instructions stored thereon which are executable by a special purpose computing apparatus of an end user mobile device to:
obtain an observation or measurement of one or more aspects of signals emanating from infrastructure concealed in walls, said signals emanating from said infrastructure concealed in walls at least in part in response to an injected signal;
obtain an observation of a current location of the end user mobile device contemporaneously with observing or measuring the one or more aspects based, at least in part, on an estimated difference between said current location and a previously known location of the end user mobile device; and
initiate transmission of one or more messages containing said observed or measured one or more aspects and said observation to a server for use in computing positioning assistance data.

20. The article of claim 19, wherein said instructions are further executable by the special purpose computing apparatus to estimate said difference between said current location and said previously known location by:
obtaining a position fix at said previously known location; and
measuring movement of said end user mobile device from said position fix to said observation of said current location.

21. The article of claim 20, wherein said instructions are further executable by the special purpose computing apparatus to measure said movement based, at least in part, on measurements obtained from one or more inertial sensors.

22. The article of claim 20, wherein said instructions are further executable by the special purpose computing apparatus to estimate said difference between said current location and said previously known location further comprises obtaining visual cue at a camera device.

23. The article of claim 20, wherein said instructions are further executable by said special purpose computing apparatus to obtain said position fix based, at least in part, on acquisition of one or more satellite positioning system (SPS) signals.

24. The article of claim 20, wherein said instructions are further executable by said special purpose computing apparatus to obtain said position fix based, at least in part, on acquisition of one or more signals transmitted from a wireless local area network access point.

25. The article of claim 20, wherein said instructions are further executable by said special purpose computing apparatus to obtain said position fix by:
observing or measuring one or more aspects of signals emanating from said infrastructure concealed in walls while positioned at said previously known location, said signals emanating from said infrastructure concealed in walls at least in part in response to said injected signal; and
estimating said previously known location of the end user mobile device based, at least in part, on application of previously determined positioning assistance data to said observed or measured one or more aspects.

26. The article of claim 19, wherein said instructions are further executable by said special purpose computing apparatus to estimate said difference between the current location and the previously known location by:
interpolating between or among the previously known location and one or more additional previously known locations of the end user mobile device.

27. An apparatus comprising:
means for observing or measuring one or more aspects of signals emanating from infrastructure concealed in walls, said signals emanating from said infrastructure concealed in walls at least in part in response to an injected signal;
means for obtaining an observation of a current location of an end user mobile device contemporaneously with the observing or measuring the one or more aspects based, at least in part, on an estimated difference between said current location and a previously known location of the end user mobile device; and
means for transmitting one or more messages containing said observed or measured one or more aspects and said observation to a server for use in computing positioning assistance data.

28. A method comprising, at an end user mobile device:
observing or measuring one or more aspects of signals emanating from infrastructure concealed in walls, said signals emanating from said infrastructure concealed in walls at least in part in response to an injected signal;
obtaining an observation of a current location of the end user mobile device contemporaneously with the observing or measuring the one or more aspects based, at least in part, on a user selection on a touchscreen of said end user mobile device over a location on a map displayed on said touchscreen; and
transmitting one or more messages containing said observed or measured one or more aspects and said observation to a server for use in computing positioning assistance data.

29. The method of claim 28, wherein said signals emanating from said infrastructure concealed in walls are further transmitted in response to a signal injected into a medium from a central location.

30. The method of claim 28, wherein said signals emanating from said infrastructure concealed in walls are further transmitted in response to a signal injected into a medium from a plurality of distributed locations.

31. The method of claim 28, wherein the infrastructure concealed in walls comprises one or more of electrical wiring, plumbing pipes, metal framing or HVAC ducting.

32. The method of claim 28, and further comprising receiving updated positioning assistance data comprising at least one or more signature values derived, at least in part, from said observed or measured one or more aspects and said observation.

33. An end user mobile device comprising:
a transceiver to transmit messages to and receive messages from a wireless network;
a touchscreen device; and
one or more processors to:
obtain an observation or measurement of one or more aspects of signals emanating from infrastructure concealed in walls, said signals emanating from said infrastructure concealed in walls at least in part in response to an injected signal;
obtain an observation of a current location of the end user mobile device contemporaneously with the observing or measuring the one or more aspects based, at least in part, on a user selection on said touchscreen device over a location on a map displayed on said touchscreen device; and
initiate transmission of one or more messages through said transceiver containing said observed or measured one or more aspects and said observation to a server for use in computing positioning assistance data.

34. The end user mobile device of claim 33, wherein said signals emanating from said infrastructure concealed in walls are further transmitted in response to a signal injected into a medium from a central location.

35. The end user mobile device of claim 33, wherein said signals emanating from said infrastructure concealed in walls further are transmitted in response to a signal injected into a medium from a plurality of distributed locations.

36. The end user mobile device of claim 33, wherein the infrastructure concealed in walls comprises one or more of electrical wiring, plumbing pipes, metal framing or HVAC ducting.

37. An article comprising
a non-transitory storage medium comprising machine-readable instructions stored thereon which are executable by a special purpose computing apparatus of an end user mobile device to:
obtain an observation or measurement of one or more aspects of signals emanating from infrastructure concealed in walls, said signals emanating from said infrastructure concealed in walls at least in part in response to an injected signal;
obtain an observation of a current location of the end user mobile device contemporaneously with the observing or measuring the one or more aspects based, at least in part, on a user selection on a touchscreen device over a location on a map displayed on said touchscreen device; and
initiate transmission of one or more messages containing said observed or measured one or more aspects and said observation to a server for use in computing positioning assistance data.

38. The article of claim 37, wherein said signals transmitted by said infrastructure concealed in walls are transmitted in response to a signal injected into a transmission medium from a central location.

39. The article of claim 37, wherein said signals transmitted by said infrastructure concealed in walls are transmitted in response to a signal injected into a transmission medium from a plurality of distributed locations.

40. The article of claim 37, wherein the infrastructure concealed in walls comprises one or more of electrical wiring, plumbing pipes, metal framing or HVAC ducting.

41. An apparatus comprising:
means for observing or measuring one or more aspects of signals emanating from said infrastructure concealed in walls, said signals emanating from said infrastructure concealed in walls at least in part in response to an injected signal;
means for obtaining an observation of a current location of an end user mobile device contemporaneously with the observing or measuring the one or more aspects based, at least in part, on a user selection on a touchscreen of said end user mobile device over a location on a map displayed on said touchscreen; and
means for transmitting one or more messages containing said observed or measured one or more aspects and said observation to a server for use in computing positioning assistance data.
